(19) United States
(12) Patent Application Publication
(10) Pub. No.: US 2006/0112776 A1
(43) Pub. Date: Jun. 1, 2006

(54) Actuating device

(75) Inventors: Jorg Hillen, Nortershausen (DE); Michael Kleinmann, Meisbach (DE); Heiko Schilken, Lutzereth (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/287,666

(22) Filed: Nov. 28, 2005

(30) Foreign Application Priority Data
Nov. 27, 2004 (DE) 102004057363.8-12

(51) Int. Cl. F16H 21/50

(52) U.S. Cl. 74/25

(57) ABSTRACT

An actuating device for displacing a movable component having two articulation points includes a pivoting body and a traction member. The pivoting body can be rotated about an axis by a drive unit, the pivoting body having a pair of deflection elements on opposite sides of the axis. The traction member passes through the pivoting body and is displaceable between the deflection elements, the traction member being windable onto and unwindable from the pivoting body and having a pair of opposed ends which are fixed to respective articulation points of the moveable component. When the pivoting body is rotated, a uniform tensile force is exerted on the opposed ends of the traction member.

### BACKGROUND OF THE INVENTION

1. Field of the Invention

The invention relates to an actuating device for a movable component, in particular for a pivotable and/or displaceable closing component of a motor vehicle, having two partial traction means acting on a respective point of articulation of the component, and having a drive unit which has a rotatably driveable pivoting body for transmitting force to the partial traction means, it being possible for the partial traction means to be wound onto and unwound from the pivoting body.

2. Description of the Related Art

An actuating device of this type is known, for example, as a boot lid actuation for a passenger vehicle. In this case, an adjustment mechanism is provided and can be used to activate two displacement mechanisms which serve to displace a point of articulation of a respective gas-filled compression spring. The gas-filled compression springs are arranged on opposite sides of the boot lid and serve to open the boot lid. The displacement mechanisms are to be adjustable synchronously with the adjustment mechanism. For this purpose, an adjustment unit of the adjustment mechanism has an eccentric which can be set into rotation by motor and is designed, for example, as a lever-type joint. Lever arms are articulated on opposite end regions of the eccentric and on them, in turn, a respective pull and push bar of a respective flexible traction means designed as a pull-push cable are articulated. The pull-push cables lead to a respective associated displacement mechanism for the points of articulation of the gas-filled compression springs. In particular, in the event of a different change in length of the traction means occurring over the course of time, a synchronous actuation of the displacement mechanisms is no longer ensured, and there is the risk of the boot lid becoming distorted.

In addition, a drive device, which has a cord-type drive, for a sliding roof cover of a vehicle is known, in which a cord guided in an endless loop can be wound onto two winding drums driven in the same direction. In addition, a central section of the cord loops around a further winding drum and, as a result, divides the cord into two cord strands, of which one acts in each case on the sliding roof cover of the vehicle, on opposite sides of the same. In the event of a different change in length of the cord strands, a non-uniform introduction of force into the sliding roof cover of the vehicle occurs, which cover, as a result, threatens to become jammed and to become wedged.

### SUMMARY OF THE INVENTION

Starting from the prior art, the present invention is based on the object of introducing a uniform force into the points of articulation of the component, and automatically compensating for a change in length of the partial traction means.

According to the invention, the partial traction means are connected to each other forming a single traction means, the traction means reaches through the pivoting body in a displaceable manner between two deflection elements, which are arranged on the pivoting body and, during pivoting of the pivoting body, exert a tensile force on respective ends of the traction means

With the invention, a force of equal magnitude is introduced into each of the two points of articulation of the component to be moved. An equalization of force between the partial traction means, which are formed by both ends of the one, single traction means, takes place automatically, to be precise, by means of a displacement of the traction means in relation to the pivoting body, which displacement brings about the equalization of force. With the displacement, an equalization of length between the ends of the traction means takes place, so that each end of the traction means is spaced apart by the same traction means length in each case from an associated deflection element of the pivoting body. A distortion of the component or a wedging or jamming of the component during its movement due to a different introduction of force into the points of articulation is reliably avoided by the invention. The actuating device according to the invention is therefore suitable in particular for opening and/or closing a large, only partially flexurally rigid closing component, such as, for example, a tailgate of a motor vehicle. For example, the invention is also particularly suitable for actuating a sliding roof or a sliding door of a motor vehicle. Also of advantage in the event of use in motor vehicles is the easy construction of the actuating device, which has only a low weight, and its high operational reliability and durability. It is favourable that, in comparison to the known prior art, in the case of the invention only a single traction means has to be provided which is looped through the pivoting body by a—generally small—extent during an actuating operation of the component to be moved. As a result, for example, expansions and shrinkages of the traction means are compensated for in a simple manner. Differences in length of the traction means are compensated for and the movements of both points of articulation of the component which is to be moved are synchronized. If a movement of the traction means is initiated by rotation of the pivoting body, the traction means can slide through the pivoting body until the same force prevails at both ends of the traction means; it is thus ensured that, for example, both hinges of a boot flap begin at the same time to transmit a closing movement to the boot flap. A cord, in particular wire cord, or cable, which can preferably be designed on both sides of the pivoting body as a Bowden cable, is preferably suitable as the traction means.

According to an advantageous development of the invention, an identical and also a high tensile force can be applied particularly reliably to the ends of the traction means if the deflection elements are offset with respect to each other in the longitudinal direction of the traction means.

It would be conceivable for the traction means to reach through the pivoting body obliquely with respect to the pivot axis and/or in a plurality of planes arranged at an angle to one another. By contrast, the operational reliability of the actuating device is further increased and its wear is minimized if, according to an advantageous of the invention, the traction means reaches through the pivoting body in a plane perpendicular to the pivot axis of the pivoting body.

In a simple embodiment of the invention, the deflection means could be formed, for example, by a respective eyelet, which is spaced apart from the pivot axis of the pivoting body, is fastened to the pivoting body and has the traction means reaching through it, or by journals on the pivoting body. By contrast, in particular the guidance of the traction means in the pivoting body is advantageously improved if, according to a development of the invention, the deflection elements have edge sections of a recess, which reaches through the pivoting body, for guiding the traction means.

The recess of the pivoting body could be, for example, a hole through the pivoting body. However, the production, in particular the assembly, of the actuating device is simplified, according to an advantageous development of the invention, if the recess is a groove which is open on an end-side surface of the pivoting body. The traction means can simply be placed into this groove and subsequently covered, for example, by means of a cover.

In principle, the profile of the recess in the pivoting body may be as desired. However, a recess which can be manufactured in this simple manner is advantageously obtained, according to a development of the invention, if the recess has a linear profile.

According to another advantageous development of the invention, the recess has an S-like profile. The traction means is therefore guided in the pivoting body in a manner which particularly protects the traction means and minimizes friction and wear. The risk of the traction means buckling is therefore virtually excluded.

According to another advantageous development of the invention the recess reaches through the pivoting body in a manner intercepting the pivot axis, so that the pivoting body can in a simple manner have a symmetrical construction with uniform distribution of masses and in balance-free movement.

In particular, in order to form a bearing journal which can be mounted on both sides of the pivoting body, it is of particular advantage if, according to another development of the invention, the recess reaches through the pivoting body at a distance from the pivot axis.

A reduction in the friction between pivoting body and traction means advantageously arises if, according to another advantageous development of the invention, the deflection elements have rollers arranged rotatably on the pivoting body. According to another advantageous development of the invention, the friction between traction means and pivoting body can also or additionally be further reduced if the deflection elements and/or the traction means have a friction-reducing surface. A friction-reducing surface of this type may be produced, for example, by means of lubrication. However, the friction-reducing surface may also be, for example, a coating, for example with polytetrafluoroethylene (PTFE).

In particular if the traction means has to cover a not-inconsiderable distance in order to move the component, another development of the invention is particularly advantageous, in which development the pivoting body has a drum onto which the traction means can be coiled during pivoting of the pivoting body.

In order to actuate a plurality of components by means of only one actuating device, a pivoting body is conceivable which has two or more abovementioned recesses which, in a simple form, may be holes in the pivoting body; however, it may also be, for example, a recess in double S-form or in the form of the number 8. With the actuation device according to the invention a plurality of components can be moved at the same time or the one component can be moved both in an opening direction and in a closing direction with a single actuating device if, according to an advantageous development of the invention, two traction means reaching through the pivoting body in a displaceable manner in different, parallel planes are provided. It is then optionally possible for two traction means ends to be wound onto a drum of the pivoting body and two traction means ends to be unwound therefrom, to be precise, at the same time.

Exemplary embodiments of the invention are illustrated in schematized form in the drawing and are explained in more detail below, with corresponding elements being provided in all of the figures with the same reference numbers.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a side view of a first actuating device,

FIG. 2 shows a side view of a second actuating device,

FIG. 3 shows a pivoting body of the actuating device according to FIG. 2 in side view,

FIG. 4 shows the pivoting body according to FIG. 3 in a partial section view,

FIG. 5 shows an alternative pivoting body in side view,

FIG. 6 shows the pivoting body according to FIG. 5 in a sectional view, and

FIG. 7 shows a side view of an actuation device with two traction ends,

FIG. 8 shows a view of a first exemplary embodiment of a pivoting body arrangement,

FIG. 9 shows a side view of a pivoting body of the pivoting body arrangement according to FIG. 8,

FIG. 10 shows the pivoting body according to FIG. 9 in partially cutaway view,

FIG. 11 shows a side view of a second pivoting body of the pivoting body arrangement according to FIG. 8,

FIG. 12 shows the second pivoting body according to FIG. 11 in partially cutaway view,

FIG. 13 shows a view of a second exemplary embodiment of a pivoting body arrangement,

FIG. 14 shows a side view of a pivoting body of the pivoting body arrangement according to FIG. 13,

FIG. 15 shows the pivoting body according to FIG. 14 in partially cutaway view,

FIG. 16 shows a side view of a second pivoting body of the pivoting body arrangement according to FIG. 13, and

FIG. 17 shows the second pivoting body according to FIG. 16 in partially cutaway view.

### DETAILED DESCRIPTION OF THE PRESENTLY PREFERRED EMBODIMENTS

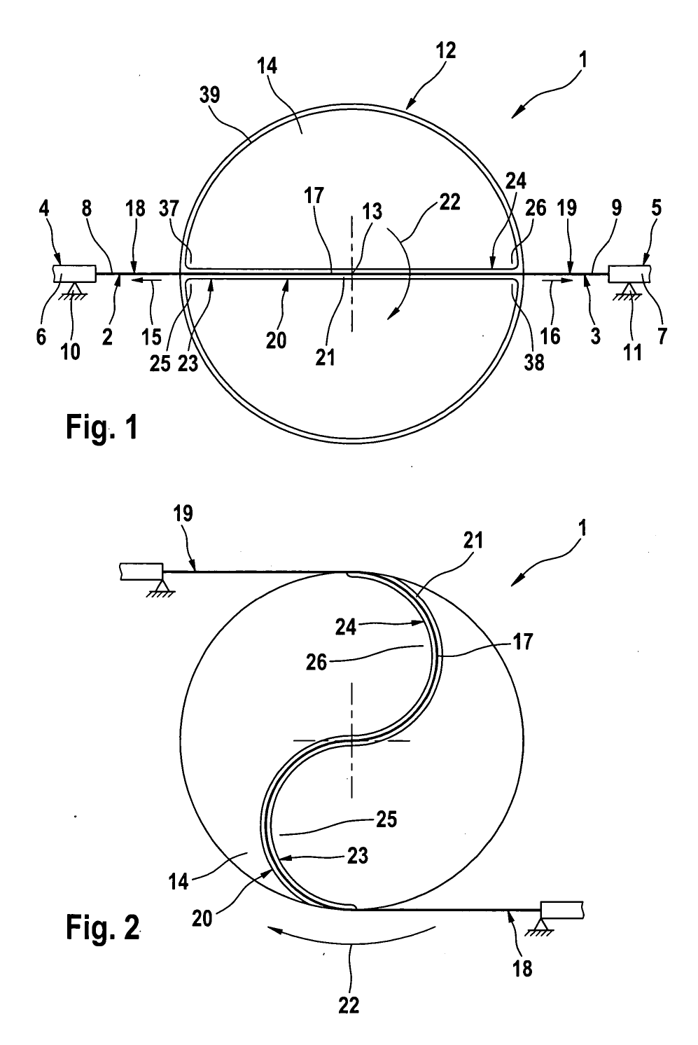

FIG. 1 shows an actuating device 1 for a moveable component (not illustrated here), in particular a tailgate, of a passenger vehicle in a side view. The actuating device comprises two partial traction members 2, 3, which are designed in each case as a Bowden cable 4, 5, to be precise in the form of wire cords 8, 9 guided in tubes 6, 7. The tubes 6, 7 are held on the body of the passenger vehicle at fastening points 10, 11.

The partial traction members do not have to be Bowden cables but rather may also be simple cords or straps. These cords may be composed of wire or of another material such as, for example, plastic.

The actuating device 1 furthermore comprises a drive unit 12 with a pivoting body 14 which can be rotated about a pivot axis 13. By means of the drive unit 12, a respective tensile force, symbolized by arrows 15, 16, can be applied to the partial traction members 2, 3. The partial traction members 2, 3 transmit the tensile force in each case via a point of articulation to the movable component in order to open or to close the latter. The partial traction members 2, 3 are connected to each other forming a single traction member 17, the partial traction members 2, 3 forming a respective end 18, 19 of the traction member 17. The traction member 17 is therefore a single wire cord. Within the pivoting body 14, the traction member 17 is arranged displaceably in a recess 20, which reaches through the pivoting body 14 and is designed here as a groove 21 which is open on a surface of the pivoting body 14 and has a linear profile.

In this case, the traction member 17 reaches through the pivoting body 14 in a plane perpendicular to the pivot axis 13 of the pivoting body 14. The pivoting body 14 is of symmetrical design, so that the recess 20 accommodating the traction member 17 reaches through the pivoting body 14 in a manner intercepting the pivot axis 13.

The pivoting body 14 can be rotated about the pivot axis 13 in a direction symbolized by an arrow 22, with deflection elements 25, 26 of the pivoting body 14, which deflection elements have edge sections 23, 24 of the groove 21, exerting the abovementioned tensile force on the ends 18, 19 of the traction member 17. It can be seen that the deflection elements 25, 26 are offset for this purpose with respect to each other in the longitudinal direction of the traction member 17. The pivoting body 14 also has a drum 39 onto which the traction member 17 can be coiled during pivoting of the pivoting body 14.

In order to subject the traction member 17 to a force also in a direction of rotation opposed to the direction of rotation shown for the pivoting body 14, edge sections of the groove 21, which edge sections lie opposite the previously-mentioned deflection elements 25, 26 with respect to the groove 21, can also be used as deflection elements 37, 38.

FIG. 2 shows an actuating device 1 with a pivoting body 14 having a recess 20 designed as a groove 21 which accommodates a traction member 17 and has an S-shaped profile. In the case of this embodiment, the edge sections 23, 24 of the groove 21, which edge sections are arranged in the valleys of the S providing the profile of the groove 21, are part of deflection elements 25, 26. The corresponding direction of rotation of the pivoting body 14 for exerting a tensile force on the ends 18, 19 of the traction member 17 is symbolized by an arrow 22.

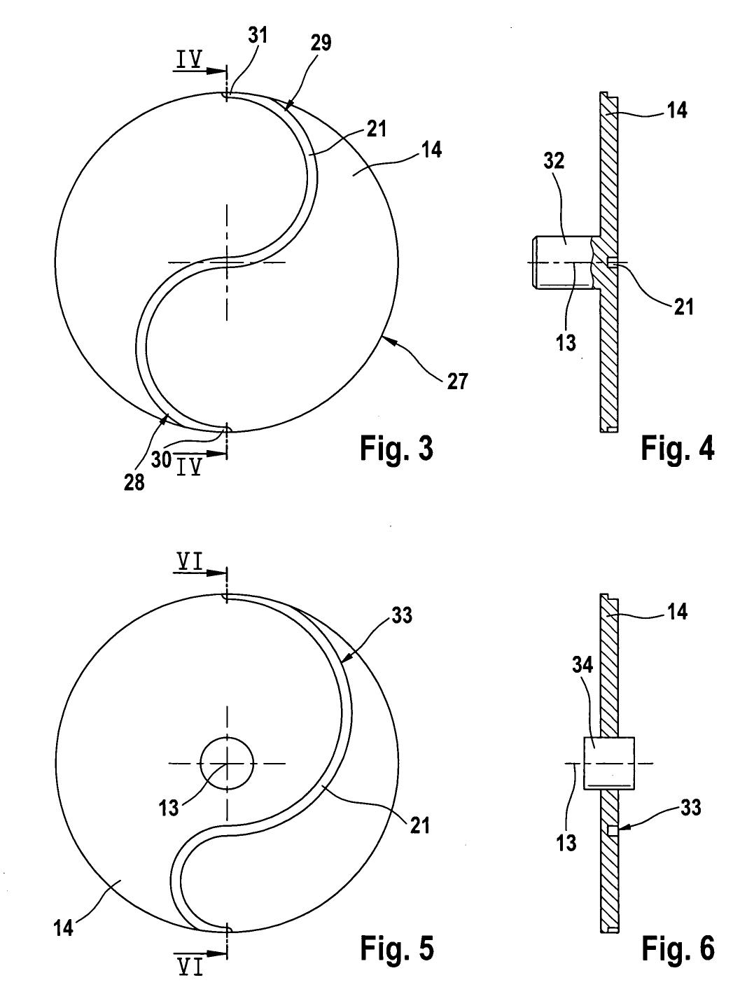

The pivoting body 14 is illustrated in detail in FIG. 3. It can be seen that the pivoting body 14 has a circular outer contour 27 into which end regions 28, 29 of the S-shaped groove 21 merge tangentially. Ends 30, 31 of the groove 21 are provided in each case with a rounded portion in order to protect the traction member 17 to be accommodated displaceably in the groove 21 (compare FIG. 2).

FIG. 4 shows the pivoting body 14 in a partial section view on line IV-IV according to FIG. 3. The groove 21 reaches through the pivoting body 14 in a manner intercepting the pivot axis 13. On its side lying opposite the groove 21, the pivoting body 14 has a bearing journal 32 for mounting the pivoting body 14 on one side in a drive unit.

FIG. 5 illustrates an alternative pivoting body 14 with a recess 33 which has an S-shaped profile and is designed as a groove 21. This pivoting body 14 is not constructed symmetrically insofar as the recess 33 reaches through the pivoting body 14 at a distance from the pivot axis 13 thereof. This is particularly clear in FIG. 6 which shows the pivoting body 14 in a sectional view on line VI-VI according to FIG. 5. As a result, the pivoting body 14 can have a bearing journal 34, which protrudes on both sides, for mounting the pivoting body 14 on two sides.

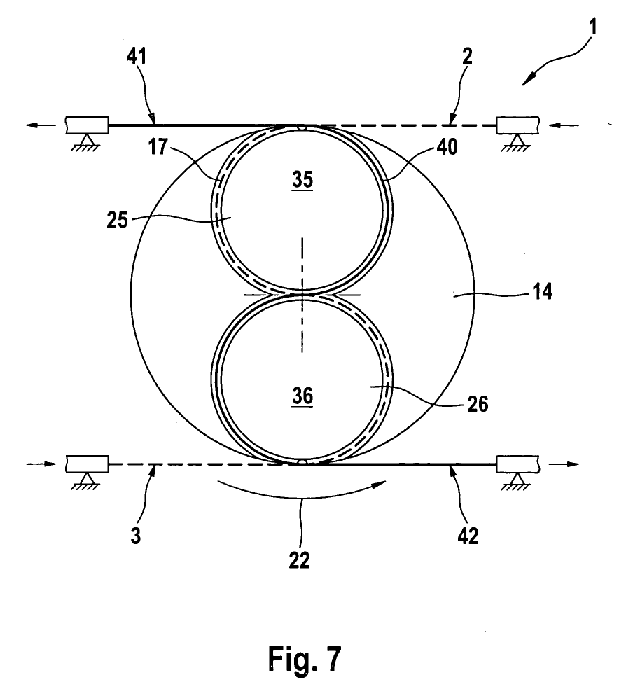

FIG. 7 shows an exemplary embodiment of an actuating device 1 with a pivoting body 14, which has rollers 35, 36 mounted rotatably on its surface as deflection elements 25, 26. In addition, two traction members 17, 40 which reach through the pivoting body 14 in a displaceable manner in different, parallel planes, are provided here, the traction members being formed in each case from two partial traction means 2, 3, 41, 42. In a direction of rotation of the pivoting body 14, that is symbolized by an arrow 22, a tensile force is exerted on the first traction member 17 (illustrated by dashed lines), and the second traction members 40 (illustrated by means of a solid line) is relieved of load. In the case of an opposed direction of rotation of the pivoting body 14, the first traction member is relieved of load and a tensile force is exerted on the second traction member 40.

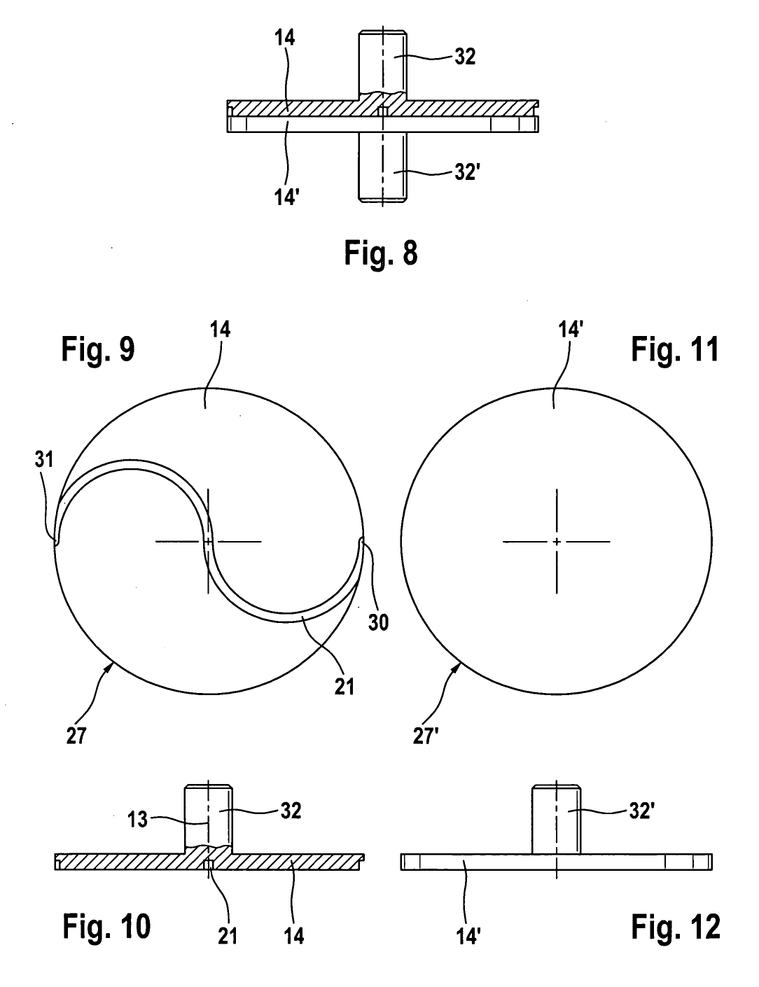

The pivoting body 14 illustrated in FIGS. 8 to 10 corresponds to the pivoting body 14 illustrated in FIGS. 3 and 4. In order to close the opening of the groove 21, a further pivoting body 14′ which corresponds to the pivoting body 14 but does not have a groove 21 is placed onto the circular surface of the pivoting body 14, which circular surface faces away from the bearing journal 32 and into which the groove 21 opens. Furthermore, the pivoting body 14 can have a bearing journal 32 which protrudes on both sides, for mounting the pivoting body 14 on two sides.

The two pivoting bodies 14 and 14′ are connected in a rotationally fixed manner to each other by drivers (not illustrated), such as studs or pins of the one pivoting body, which engage in corresponding recesses of the other pivoting body.

The pivot axes 32 and 32′, which project away in an opposed manner to each other, permit the pivoting body arrangement to be mounted in a manner free from tilting moments.

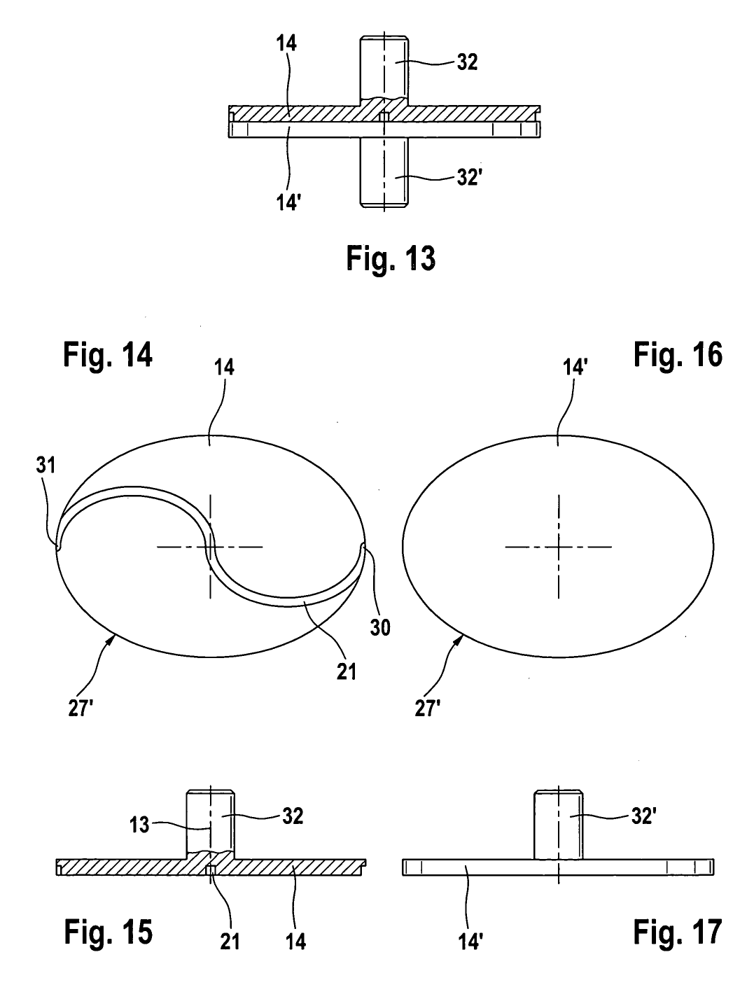

In the case of the pivoting body arrangement illustrated in FIGS. 13 to 17, the construction corresponds to the pivoting body arrangement illustrated in FIGS. 8 to 12 with the difference that the outer contour 27′ is not circular, but rather is oval, enabling a changing profile of moments to be achieved. In principle, the outer contour 27′ may also have a different curved profile in order to be able to obtain a respectively desired profile of moments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An actuating device for displacing a movable component having two articulation points, the actuating device comprising:
a pivoting body which can be rotated about an axis by a drive unit, the pivoting body having a pair of deflection elements on opposite sides of the axis; and
a first traction member passing through the pivoting body and being displaceable between the deflection elements, the traction member being windable onto and unwindable from the pivoting body and having a pair of opposed ends which are fixed to respective articulation points of the moveable component;
whereby rotating said pivoting body exerts a uniform tensile force on the opposed ends of the traction member.

2. The actuating device of claim 1 wherein the deflection elements are offset with respect to each other in the longitudinal direction of the traction member.

3. The actuating device of claim 1 wherein the traction member passes through the pivoting body in a plane perpendicular to the pivot axis.

4. The actuating device of claim 1 wherein the pivoting member has a recess through which the traction member passes, the recess having edge sections which form the deflection elements.

5. The actuating device of claim 4 wherein the pivoting body has an axial end surface, the recess comprising an open groove in the end surface.

6. The actuating device of claim 4 wherein the recess has a rectilinear profile.

7. The actuating device of claim 4 wherein the recess has an S-profile.

8. The actuating device of claim 4 wherein the recess passes through the axis of the pivoting body.

9. The actuating device of claim 4 wherein the recess is spaced from the axis of the pivoting body.

10. The actuating device of claim 1 wherein the deflection elements comprise a pair of rollers arranged rotatably on the pivoting body.

11. The actuating device of claim 1 wherein at least one of said deflection elements and said traction member have a low friction surface.

12. The actuating device of claim 1 wherein the pivoting body comprises a drum onto which the traction member is wound during pivoting of the pivoting body.

13. The actuating device of claim 1 further comprising a second traction member passing through the pivoting body, the first and second traction members being in spaced apart parallel planes.
